(19) United States
(12) Patent Application Publication
(10) Pub. No.: US 2008/0238873 A1
(43) Pub. Date: Oct. 2, 2008

(54) MOUSE INCLUDING STORAGE

(76) Inventor: Faramarz Dolatshahi, Gilbert, AZ (US)

Correspondence Address: INTEL CORPORATION;c/o INTELLEVATE, LLC, P.O. BOX 52050, MINNEAPOLIS, MN, 55402, US

(21) Appl. No.: 11/694,775

(22) Filed: Mar. 30, 2007

(51) Int. Cl. G06F 3/033

(52) U.S. Cl. 345/162

(57) ABSTRACT

In some embodiments a mouse includes a user interface to interact with a computing device and storage to store information received from the computing device. Other embodiments are described and claimed.

### TECHNICAL FIELD

The inventions generally relate to a mouse including storage.

### BACKGROUND

A computer mouse is a device that controls the movement of a cursor or pointer on a display screen. A mouse is typically a small object that can be rolled along a hard flat surface. As the mouse is moved, the pointer on the display screen moves in the same direction. Mice typically contain at least one button (usually more than one button). Each button on a mouse has different functions, for example, depending on which program is running on the computer. Some mice also include a scroll wheel, for example, used for scrolling through long documents. A mouse is important for graphical user interfaces (GUIs) of computers because it can be used to point to options and objects and click on those options and objects, for example. A mouse can also be used, for example, in graphics programs that allow a user to draw pictures using the mouse like a pen, pencil, or paintbrush. Mice have previously been used that rely on mechanical operation, optomechanical operation, and/or optical operation, for example. A mouse using mechanical operation may use, for example, a rubber or metal ball on its underside that can roll in all directions and having mechanical sensors in the mouse to detect a direction in which the ball is rolling so that the screen pointer can be moved accordingly. A mouse using optomechanical operation may use, for example, similar mechanical features as a mechanical mouse, and may further include optical sensors to detect motion of the ball. An optical mouse may use a laser to detect the mouse's movement. A mouse can connect and/or couple to a computer using a cord (for example, using a serial port, a PS/2 port or a USB port). A mouse can also connect and/or couple to a computer in a wireless fashion (for example, using infrared or radio waves).

The inventor has recognized that it would be beneficial to enable a mouse to cut and paste data between two or more different computers that share one mouse and keyboard. Currently, for example in cases where users need to use multiple computers shared via a KVM (Keyboard, Video, Mouse) switch, users must go through tedious manual steps in order to copy data and paste it to a different computer. There is a huge amount of overhead associated with such manual steps and the possibility of human errors is a factor. Some software (such as Virtual Network Computing or VNC software used to remotely control another computer) is able to handle very limited cases of sharing between two different computers between Windows® based and some UNIX® based systems, but it does not always work, particularly when the computers are using KVM switches to allow a user to toggle between different computers. It would be beneficial to enable a mouse to cut and paste data between two or more different computers in a manner that is independent of these types of limitations.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a mouse according to some embodiments of the inventions.

FIG. 2 illustrates an apparatus according to some embodiments of the inventions.

### DETAILED DESCRIPTION

Some embodiments of the inventions relate to a mouse including storage.

Some embodiments of the inventions relate to a mouse that includes a user interface to interact with a computing device and storage (for example, a storage device) to store information received from the computing device.

In some embodiments an apparatus includes a coupled device and a mouse. The mouse includes a user interface to interact with the coupled device and storage (for example, a storage device) to store information received from the coupled device.

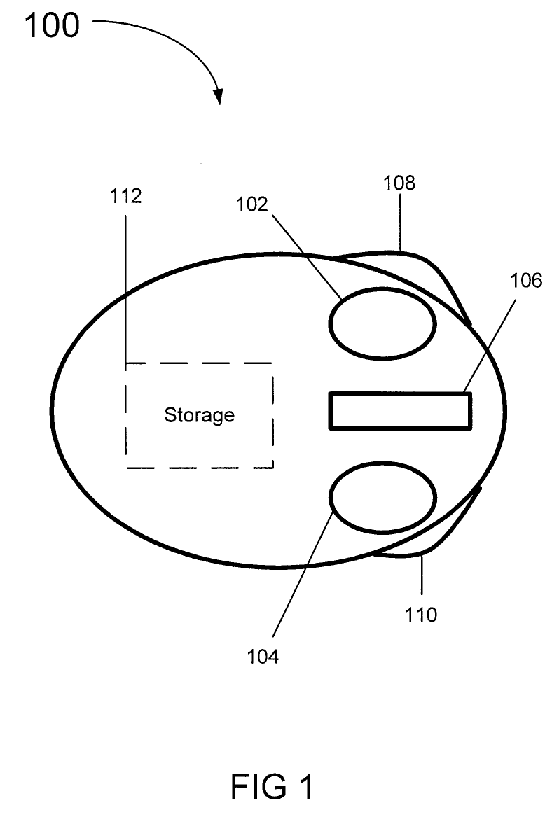

FIG. 1 illustrates a mouse 100 according to some embodiments. In some embodiments mouse 100 includes a mouse button 102, a mouse button 104, a scroll wheel 106, a button 108, a button 110, and/or a storage 112. In some embodiments buttons 102 and/or 104 are standard mouse buttons and scroll wheel 106 is a standard mouse scroll wheel. In some embodiments buttons 108 and/or 110 are standard mouse buttons with non-traditional mouse purposes. In some embodiments storage 112 is provided within a body of mouse 100. In some embodiments storage 112 includes an integrated clip board, an internal buffer, a memory, a flash memory, a hard drive, integrated memory, onboard memory, a Random Access Memory (RAM), an integrated circuit memory, and/or any other type of storage that is capable of storing information, data, etc. In some embodiments mouse 100 is a mechanical mouse, an optomechanical mouse, and/or an optical mouse. In some embodiments mouse 100 is a serial mouse, an RS-232C mouse, a PS/2 mouse, and/or a Universal Serial Bus (USB) mouse. In some embodiments, mouse 100 includes a battery compartment (for example, underneath the mouse on the opposite side from the top side of the mouse as illustrated in FIG. 1). In some embodiments, mouse 100 is a mouse to be coupled to a computing device via a cord. In some embodiments, mouse 100 is a mouse to be coupled to a computing device wirelessly (for example, in some embodiments via infrared communication, and/or via radio communication, etc.) In some embodiments mouse 100 is a wireless USB computer mouse.

In some embodiments mouse 100 includes storage 112 (for example, an integrated memory and/or integrated clip board) that enables the user to cut and paste data (for example, in some embodiments from an internal buffer maintained in the mouse brain and/or storage 112). After installing a special driver on a system (for example, a Windows® based system and/or a UNIX® based system), the user performs a cut and paste action (for example, via Control-C, Control-X and/or Control-V, via highlighting, etc.) The special driver intercepts this action and stores and pastes the data to and/or from the storage 112 (for example, the mouse integrated memory). For example, in some embodiments, the mouse 100 includes an integrated 2 GB of onboard memory as the storage 112. The software driver handles formatting and managing the storage 112 (for example, onboard memory) and also manages the writing to/from the storage 112. In some embodiments mouse 100 also maintains an internal clipboard as storage 112 and/or included within storage 112. In this manner, mouse 100 can be uncoupled (for example, physically unplugged) and coupled to (for example, plugged into) a different computer system and the user can then paste the stored data to the different computer system. In some embodiments, the storage 112 of mouse 100 can be used for storage in a manner similar to a USB storage device. In some embodiments, the storage 112 of mouse 100 is a USB storage device.

In some embodiments, storage 112 of mouse 100 is used to enable a user to cut and paste data between two or more different computers that share the mouse (and in some embodiments also share a keyboard).

In some embodiments a user is able to save a significant amount of time when using multiple computer platforms for data entry. In some embodiments, text may be copied from one platform and pasted into another platform in a manner that significantly improves the convenience of the user. In some embodiments, for example, a page of trace information may be copied from one system (for example, a Linux based computer) and pasted into an email in another system (for example, a Windows® based computer).

In some embodiments, existing technology may be used to significantly eliminate costs. For example, in some embodiments, wireless mouse communication (for example, wireless USB mouse communication) may be used, and in some embodiments general mouse drivers may be used.

In some embodiments, button 108 may be used as a copy button and/or a click button, for example, to copy if button 108 is clicked once and to cut if button 108 is clicked twice (for example, a “double click”). In some embodiments, button 110 is used as a paste button.

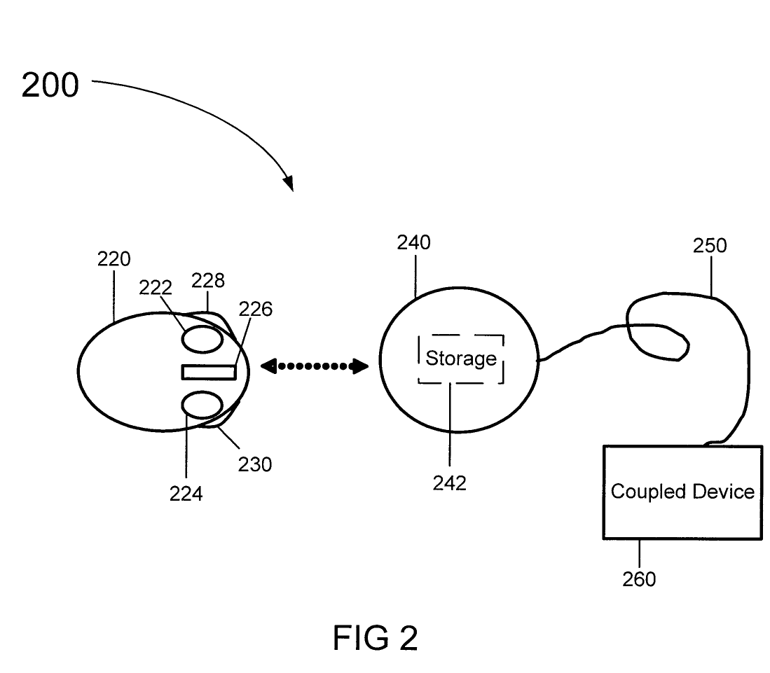

FIG. 2 illustrates an apparatus 200 according to some embodiments. In some embodiments, apparatus 200 includes a mouse 210, a mouse transmitter/receiver 240, a cable 250, and/or a coupled device 260. In some embodiments, mouse 210 includes a mouse button 222, a mouse button 224, a scroll wheel 226, a button 228, and a button 230. In some embodiments buttons mouse 220 is the same as or similar to mouse 100 illustrated in FIG. 1. In some embodiments, mouse 220 includes a storage similar to storage 112 of FIG. 1. In some embodiments, mouse 220 does not include a storage, but a storage is included in mouse transmitter/receiver 240.

In some embodiments mouse transmitter/receiver 240 includes a storage 242. In some embodiments storage 242 is used in a manner similar to storage 112 of FIG. 1. In some embodiments a combination of storage 242 and a storage within mouse 220 are used to perform the storage functions described herein.

In some embodiments, normal wireless communication is provided between mouse 220 and mouse transmitter/receiver 240 via normal mouse wireless communication (as illustrated, for example, by the dotted line between mouse 220 and mouse transmitter/receiver 240 in FIG. 2).

In some embodiments cable 250 couples the mouse transmitter/receiver to the coupled device 260. In some embodiments, coupled device 260 is a KVM switch. In some embodiments, coupled device 260 is a KVM switch and the KVM switch is coupled to at least two different computers to allow a user to toggle between the at least two different computers, where the user can control either of the at least two different computers using a single mouse and/or keyboard. In some embodiments, coupled device 260 is a computer system. In some embodiments, coupled device 260 is any device able to couple a mouse to two or more different computers.

In some embodiments storage 242 (for example, an integrated memory and/or integrated clip board) that enables the user to cut and paste data (for example, in some embodiments from an internal buffer maintained in the mouse brain and/or storage 242). After installing a special driver on a system (for example, a Windows® based system and/or a UNIX® based system), the user performs a cut and paste action (for example, via Control-X and Control-V, via highlighting, etc.) The special driver intercepts this action and stores and pastes the data to and/or from the storage 242 (for example, the mouse integrated memory). For example, in some embodiments, the mouse 220 and/or the mouse transmitter/receiver 240 includes an integrated 2 GB of onboard memory as storage. The software driver handles formatting and managing the storage 242 (for example, onboard memory) and also manages the writing to/from the storage 242. In some embodiments an internal clipboard is maintained as storage 242 and/or included within storage 242. In this manner, mouse 220 and mouse receiver 240 can be uncoupled (for example, physically unplugged via cable 250) and coupled to (for example, plugged into via cable 250) a different computer system and the user can then paste the stored data to the different computer system. In some embodiments, the storage 242 can be used for storage in a manner similar to a USB storage device. In some embodiments, the storage 242 is a USB storage device.

In some embodiments, storage 242 is used to enable a user to cut and paste data between two or more different computers that share the mouse (and in some embodiments also share a keyboard).

Although mouse 220 and mouse transmitter/receiver 240 have been illustrated in FIG. 2 as using wireless communication, some embodiments may be implemented using wired communication. Further, although mouse 220 and mouse transmitter/receiver 240 have been illustrated as separate devices in FIG. 2, they may be included in a single device, for example. In some embodiments, mouse transmitter/receiver 240 is not necessary. For example, in some embodiments a mouse such as mouse 100 and/or mouse 220 may be coupled to a coupled device without any mouse transmitter/receiver being required (for example, in a wired coupling using a cable such as cable 250).

Although some embodiments have been described herein as being related to a particular type of mouse and/or to a KVM switch, for example, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A mouse comprising:
a user interface to interact with a computing device; and
storage to store information received from the computing device.

2. The mouse of claim 1, wherein the user interface includes one or more of a button, a scroll wheel, a ball, a mechanical sensor, an optical sensor, or a laser.

3. The mouse of claim 1, wherein the mouse is a wireless mouse.

4. The mouse of claim 3, wherein the wireless mouse includes a mouse transmitter/receiver.

5. The mouse of claim 4, wherein the storage is included in the mouse transmitter/receiver.

6. The mouse of claim 1, wherein the storage is one or more of an integrated clip board, an internal buffer, a memory, a flash memory, a hard drive, integrated memory, onboard memory, a Random Access Memory (RAM), or an integrated circuit memory.

7. The mouse of claim 1, wherein the storage is capable of storing information from the computing device and allowing the stored information to be accessed by a second computing device after the mouse has been coupled to the second computing device.

8. An apparatus comprising:
a coupled device; and
a mouse including a user interface to interact with the coupled device, and storage to store information received from the coupled device.

9. The apparatus of claim 8, wherein the user interface includes one or more of a button, a scroll wheel, a ball, a mechanical sensor, an optical sensor, or a laser.

10. The apparatus of claim 8, wherein the mouse is a wireless mouse.

11. The apparatus of claim 10, wherein the wireless mouse includes a mouse transmitter/receiver

12. The apparatus of claim 11, wherein the storage is included in the mouse transmitter/receiver.

13. The apparatus of claim 8, wherein the storage is one or more of an integrated clip board, an internal buffer, a memory, a flash memory, a hard drive, integrated memory, onboard memory, a Random Access Memory (RAM), or an integrated circuit memory.

14. The apparatus of claim 8, wherein the storage is capable of storing information from the computing device and allowing the stored information to be accessed by a second computing device after the mouse has been coupled to the second computing device.

15. The apparatus of claim 8, further comprising a cable to couple the mouse to the coupled device.

16. The apparatus of claim 8, wherein the coupled device is a single computer.

17. The apparatus of claim 8, wherein the coupled device allows the mouse to interface with two or more different computers.

18. The apparatus of claim 8, wherein the coupled device is a KVM switch to allow the mouse to interface with two or more different computers.
